(19) United States
(12) Patent Application Publication
(10) Pub. No.: US 2026/0326509 A1
(43) Pub. Date: Oct. 22, 2026

(54) REFRIGERANT ASSEMBLY FOR A MOTOR VEHICLE

(71) Applicant: Modine Europe GmbH, Filderstadt (DE)

(72) Inventors: Frederik Ollanketo, Veitshöchheim (DE); Guido Koch, Karlsruhe (DE); Frank Lippke, Filderstadt (DE)

(21) Appl. No.: 19/122,909

(22) PCT Filed: Oct. 16, 2023
(86) PCT No.: PCT/EP2023/078610

§ 371 Date: Apr. 21, 2025

(30) Foreign Application Priority Data
Oct. 21, 2022 (DE) 10 2022 211 209.1

(51) Int. Cl. B60H 1/32; B60H 1/00

(52) U.S. Cl. CPC B60H 1/3223; B60H 1/00321

(57) ABSTRACT

The invention relates to a refrigerant assembly (2) for a motor vehicle, having an electric refrigerant drive (4) and at least one other component (6, 8), wherein the refrigerant drive (4) has a drive housing (18) with at least one refrigerant opening (22, 24), and the component (6, 8) is joined directly to the refrigerant opening (22, 24).

### BACKGROUND

The invention relates to a refrigerant assembly for a motor vehicle, exhibiting an electric refrigerant drive, in particular a refrigerant compressor, and at least one further component.

Motor vehicles are routinely fitted with air-conditioning systems which condition the air of the passenger compartment of the vehicle with the aid of a system constituting a refrigerant circuit. Systems of such a type basically exhibit a circuit in which a refrigerant is conducted. The refrigerant-for instance, R-744 (carbon dioxide, CO₂) or R-134a (1,1,1,2-tetrafluoroethane)—is heated in an evaporator and compressed by means of a (refrigerant) compressor, the refrigerant subsequently emitting the heat taken up via a heat-exchanger before being conducted back to the evaporator via a throttle.

A so-called scroll machine is frequently employed as refrigerant compressor in order to compress a refrigerant. The structure and mode of operation of such a scroll machine, employed as compressor for the refrigerant of an air-conditioning system of a motor vehicle, is described in DE 10 2012 104 045 A1, for instance.

### SUMMARY

The varied components in the refrigerant circuit of an air-conditioning system and/or heat-pump system are customarily connected to one another via (pipe)lines. By reason of the large number of components and interfaces, installation of the refrigerant circuit is comparatively elaborate. Furthermore, each additional interface represents a risk as regards points of leakage of the refrigerant.

The object underlying the invention is to specify a particularly suitable refrigerant assembly for a motor vehicle. In particular, the number of interfaces—and consequently the risk of leakage—in a refrigerant circuit is to be reduced.

In accordance with the invention, the object is achieved with the features of the disclosure. Advantageous configurations and developments are subjects of the dependent claims.

The basic principle of the invention consists in that components of a refrigerant circuit of a motor vehicle, which are typically connected to one another via pipelines or other additional structural parts, are mounted directly onto one another.

The refrigerant assembly according to the invention is provided for a motor vehicle and is suitable and configured for a motor vehicle. The refrigerant assembly exhibits an electric refrigerant drive—in particular, a refrigerant compressor, preferably a scroll compressor—and at least one further component. The component is, in particular, a refrigerant-circuit component, for instance a heat-pump component or a sensor element. The refrigerant drive exhibits a drive housing with at least one refrigerant aperture, the component being joined, or capable of being joined, immediately or directly—that is to say, without interposed (pipe)line—to the refrigerant aperture or, to be more exact, to the drive housing. In other words, the refrigerant aperture takes the form of a highly integrated connector for the component. As a result, a particularly suitable refrigerant assembly is realized.

The drive housing takes the form, in particular, of an aluminum die-cast part. The refrigerant aperture is, in particular, a refrigerant inlet, through which refrigerant is able to enter the drive housing, or a refrigerant outlet, through which refrigerant is able to emerge from the drive housing. In a refrigerant compressor, the refrigerant inlet is, in particular, the suction side (low-pressure side), and the refrigerant outlet is the discharge side (high-pressure side).

By virtue of the direct coupling of the component to the refrigerant drive, the number of necessary connections in the refrigerant circuit is reduced. Consequently, there are fewer individual parts and fewer sealing connections, as a result of which the production costs, the installation effort and the risk of leakage are lowered. Furthermore, the structural weight of the refrigerant assembly and also the construction-space requirement thereof are advantageously reduced.

In one embodiment, the component directly coupled to the refrigerant drive takes the form of a refrigerant sensor, in particular a pressure sensor and/or temperature sensor for capturing the refrigerant pressure or the refrigerant temperature.

Here and in the following, the conjunction “and/or” is to be understood in such a way that the features linked by means of this conjunction may have been formed both jointly and as alternatives to one another.

The refrigerant aperture is preferably the refrigerant inlet (low-pressure side, suction-pressure side). This means that a pressure sensor and/or temperature sensor has/have been installed directly in the refrigerant-intake region of the refrigerant drive. As a result, a detection of the state (pressure and/or temperature) of the refrigerant directly at the intake of the refrigerant drive is provided, as a result of which an improved regulation and/or control of the operation of the refrigerant drive is made possible.

In a conceivable embodiment, an interface for accommodating the refrigerant sensor at right angles to the refrigerant aperture has been inserted into the drive housing. The refrigerant sensor is consequently arranged substantially at right angles to the direction of flow of the refrigerant.

In a suitable development, the interface exhibits a threaded bore into which an external thread of the refrigerant sensor has been screwed in force-closed manner. As a result, a simple and reliable installation of the refrigerant sensor is guaranteed. Alternatively, the refrigerant sensor might also have been integrated into the interface by soldering or welding, which would cover both the holding function and the sealing function in one. However, in this case the refrigerant sensor would not be exchangeable in the event of servicing.

In an expedient configuration, the interface exhibits a sealing face molded onto the drive housing, against which a sealing element of the refrigerant sensor bears in sealing manner. This means that a machined interface with thread and sealing face, which accommodates the refrigerant sensor, is located in the aluminum die-cast housing of the refrigerant drive.

The sealing element preferably takes the form of an O-ring for the purpose of ensuring imperviousness. Alternatively, depending on the chosen refrigerant sensor and the design thereof, the sealing action might also be realized with the aid of other forms of seal joints, for instance by means of a rubber/metal seal joint, a pure metal seal joint, or by means of axial sealing disks.

In an additional or alternative embodiment, a heat-exchanger assembly as component has been joined directly to the refrigerant drive. The heat-exchanger assembly is provided and configured for the purpose of conducting refrigerant, a fluidic connection having been realized between the refrigerant aperture and the heat-exchanger assembly. By virtue of the direct fluidic connection between the refrigerant aperture and the heat-exchanger assembly, fewer losses of pressure of the refrigerant occur, since no pipelines potentially narrowing the cross-section and diverting the refrigerant are present. As a result, the efficiency of the refrigerant drive is improved.

The heat-exchanger assembly—taking the form, for instance, of a heat-exchanger/block-soldered assembly—exhibits several base plates, two plate-type heat-exchangers (chiller and internal heat-exchanger), several soldered-on aluminum blocks, sensors, valves and seal joints. The aluminum block(s) has/have been soldered on the base plates of one or more plate-type heat-exchangers. Both the aluminum block and the plate and the heat-exchanger(s) itself/themselves contain bores, apertures and other internal cavities through which the refrigerant flows.

The aluminum block soldered onto the heat-exchanger preferably constitutes the interface for direct installation at the refrigerant aperture, in particular at the refrigerant intake.

In a conceivable configuration, the heat-exchanger assembly, in particular the aluminum block, exhibits a protruding nozzle which has been inserted in sealing manner into a corresponding receptacle of the refrigerant aperture. As a result, a particularly simple and reduced-effort plug-in installation is made possible. The heat-exchanger assembly or, to be more exact, the aluminum block consequently exhibits a “paternal” nozzle which preferably bears an O-ring seal for the purpose of sealing. The nozzle has been inserted into the “maternal” mating contour of the receptacle on the drive housing. The nozzle (and the mating interface or receptacle on the drive housing) may also exhibit a geometry for an axial form of seal joint.

In a suitable development, a through-bore, adjacent to the refrigerant aperture, has been introduced into the drive housing, a screw element, which has been screwed into a threaded bore of the heat-exchanger assembly and consequently fixes the heat-exchanger assembly to the drive housing in force-closed manner, being seated in the through-bore. For instance, the aluminum block has been provided with an M8 threaded blind bore. The through-bore for a screw element taking the form of an M8 screw which fixes the aluminum block to the drive housing has been provided near the maternal mating contour or receptacle.

Alternatively, other screw sizes and numbers of screws for the screw element may be provided, for example two M6 screws instead of one M8 screw. Alternatively, it is furthermore possible to reverse the joining-direction—that is to say, to introduce the threaded bore into the drive housing, and the feed-through aperture in the aluminum block of the heat-exchanger assembly.

In one possible embodiment, a joining pin has been pressed into one of the two partners to be joined (heat-exchanger assembly, drive housing), a corresponding (receiving) bore having been provided in the mating part. For instance, the drive housing exhibits a protruding joining pin which engages, with sufficient joining play, in a receiving bore of the heat-exchanger assembly. The joining pin and the receiving bore enable a prepositioning or rough positioning in the course of installation.

Here and in the following, by a “form closure” or a “form-closed connection” between at least two interconnected parts it will be understood, in particular, that the cohesion of the interconnected parts is effected at least in one direction by a direct interlocking of contours of the parts themselves or by an indirect interlocking via an additional connecting part. The “blocking” of a mutual motion in this direction is accordingly effected in a manner conditioned by form.

Here and in the following, by a “force closure” or a “force-closed connection” between at least two interconnected parts it will be understood, in particular, that the interconnected parts are prevented from sliding off one another by reason of a frictional force acting between them. If there is no “connecting force” bringing about this frictional force (this means the force that presses the parts against one another, for instance a screw force or the force due to weight itself), the force-closed connection cannot be maintained and may consequently be released.

### BRIEF DESCRIPTION OF THE DRAWINGS

An exemplary embodiment of the invention is elucidated in more detail below with reference to a drawing. Shown therein, in simplified representations, are:

FIG. 1 in side view, a refrigerant assembly with a refrigerant drive and with a refrigerant sensor and also with a heat-exchanger assembly,

FIG. 2 in front view, the refrigerant assembly,

FIG. 3 in top view, the refrigerant assembly,

FIG. 4a in sectional view along section line IV-IV according to FIG. 3, portions of the refrigerant drive and the heat-exchanger assembly in a partly disassembled state,

FIG. 4b in sectional view along section line IV-IV according to FIG. 3, portions of the refrigerant drive and the heat-exchanger assembly in an assembled state,

FIG. 5a in sectional view along section line V-V according to FIG. 2, portions of the refrigerant drive and the refrigerant sensor in a partly disassembled state, and

FIG. 5b in sectional view along section line V-V according to FIG. 2, portions of the refrigerant drive and the refrigerant sensor in an assembled state.

### DETAILED DESCRIPTION

Parts and quantities corresponding to one another have been provided with the same reference symbols invariably in all the figures.

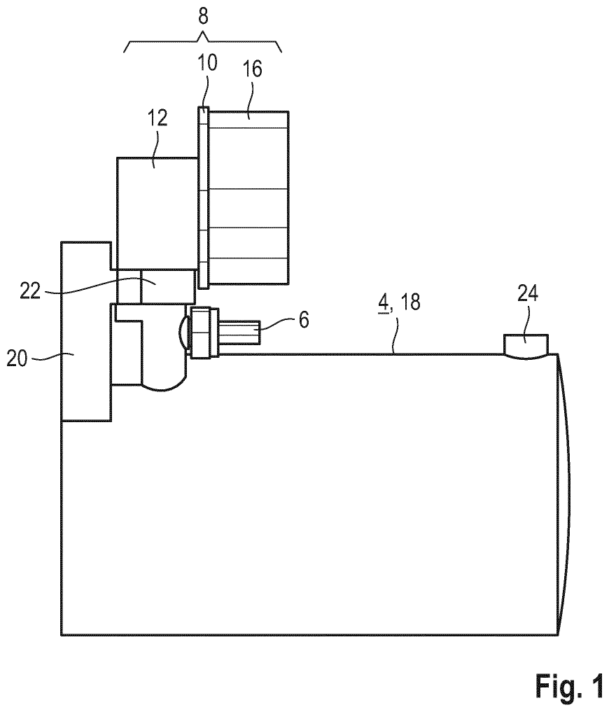

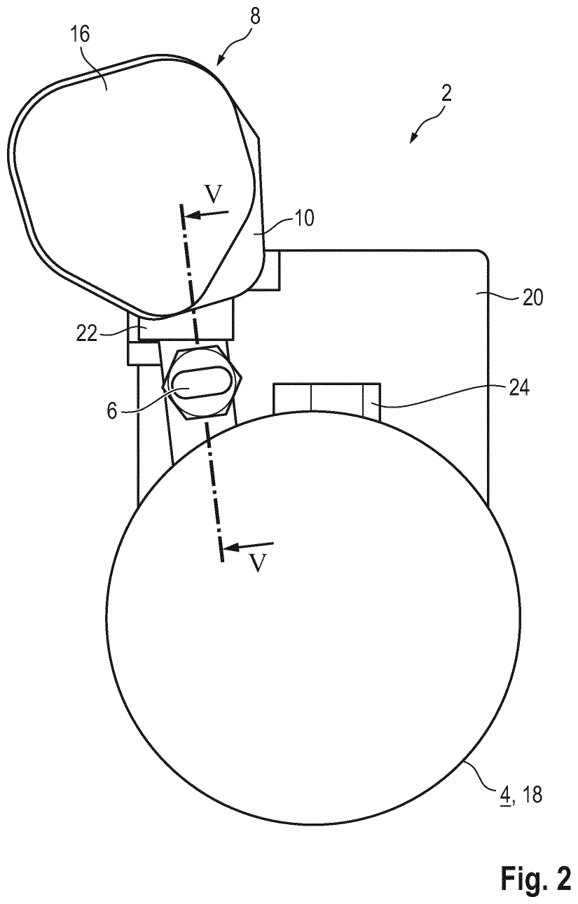

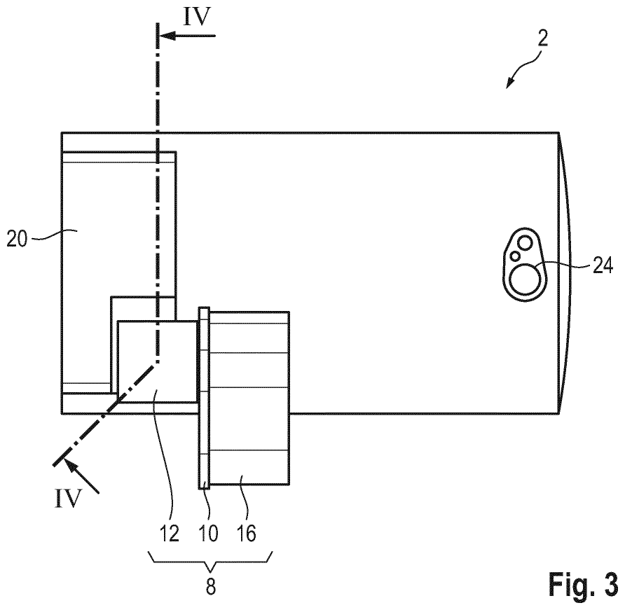

FIG. 1 to FIG. 3 show a refrigerant assembly 2 according to the invention in different perspectives. The refrigerant assembly 2 exhibits a refrigerant drive 4, hereinafter also designated as refrigerant compressor or scroll compressor, and two components 6, 8 joined thereto. Component 6 takes the form of a refrigerant sensor, in particular a pressure-and-temperature sensor, and component 8 takes the form of a heat-exchanger assembly.

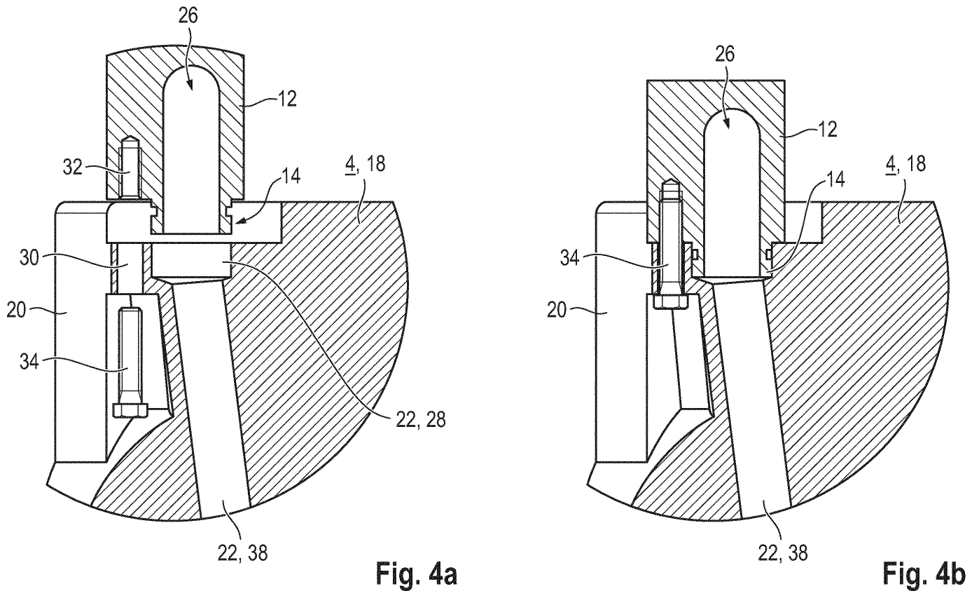

The heat-exchanger assembly 8 is, in particular, a heat-exchanger/block-soldered assembly with several base plates, two plate-type heat-exchangers, several soldered-on aluminum blocks, sensors, valves and seal joints. In the figures, merely one base plate 10, one aluminum block 12 with a nozzle 14 (FIG. 4a, FIG. 4b), and one (plate-type) heat-exchanger 16 have been represented in simplified manner. The aluminum block 12 has been joined to the base plate 10 of the heat-exchanger 16 by means of a soldered connection.

The scroll compressor 4 exhibits a drive housing or compressor housing 18. The compressor housing 18 takes the form of an aluminum die-cast part. The compressor housing 18, which for instance is cylindrical, exhibits an electronics region 20 in the form of an electronics compartment molded on integrally, that is to say, in one piece or monolithically, in which electronics (not shown in any detail) are accommodated. In its opposing end regions the compressor housing 18 exhibits, respectively, a refrigerant aperture 22, 24 by way of (refrigerant) inlet 22 (refrigerant intake, feed) and by way of (refrigerant) outlet 24, by means of which the scroll compressor 4 is coupled to a refrigerant circuit.

The inlet 22 has been molded on adjacent to the electronics region 20 of the compressor housing 18, so that a cooling or a temperature control of the electronics by means of the inflowing refrigerant is made possible. The outlet 24 has been molded on a base of a compressor housing 18. In the coupled state, the inlet 22 constitutes the low-pressure side or suction side (suction-gas side), and the outlet 24 constitutes the high-pressure side or pump side (pumping side) of the scroll compressor 4.

In accordance with the invention, the refrigerant sensor 6 and the heat-exchanger assembly 8 have been joined to the refrigerant drive 4 directly without interposed pipelines.

An installation of the heat-exchanger assembly 8 on the refrigerant drive 4 is elucidated in more detail below with reference to FIGS. 4a and 4b. FIG. 4a and FIG. 4b show portions of a direct fluidic connection between the inlet 22 and an integrated refrigerant duct 26 which has been introduced into the aluminum block 12.

The aluminum block 12 and the nozzle 14 constitute an adapter of the heat-exchanger assembly 8 for the purpose of coupling to the inlet 22. The inlet 22 exhibits a receptacle 28 corresponding to the nozzle 14, into which the nozzle 14 is inserted in sealing manner. For instance, an O-ring, not shown in any detail, has been placed onto the nozzle 14 for the purpose of, in particular, radial sealing.

In order to prevent an undesirable sliding of the nozzle 14 out of the receptacle 28, the aluminum block 12 has been joined to the compressor housing 18 in form-closed and/or force-closed manner by means of a screw connection.

As is evident in FIG. 4a in particular, a through-bore 30, adjacent to the inlet 22, has been introduced into the compressor housing 18. The through-bore 30 is arranged in alignment with a threaded bore 32, in particular with a threaded blind bore, of the aluminum block 12. For the purpose of fixing the aluminum block 12, a screw element 34, for instance an M8 screw, has been screwed into the threaded bore 32 via the through-bore 30. By virtue of the arrangement adjacent to the receptacle 28 or, to be more exact, the nozzle 14, a sufficient and operationally reliable sealing pressure is made possible by means of the screw fastening.

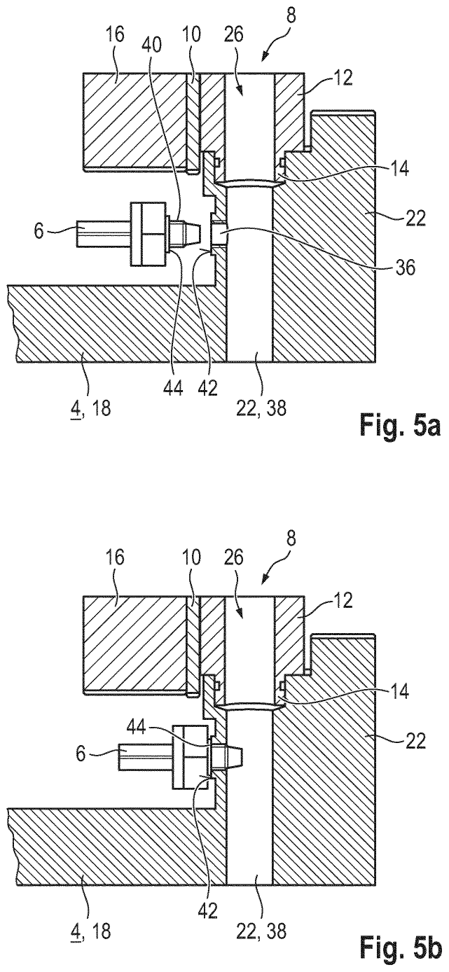

An installation of the refrigerant sensor 6 on the refrigerant drive 4 is elucidated in more detail below with reference to FIGS. 5a and 5b. FIG. 5a and FIG. 5b show portions of an interface for direct installation of the refrigerant sensor 6.

As is evident comparatively clearly in the representations shown in FIG. 5a and FIG. 5b, the interface exhibits a receptacle 36 which as a threaded bore is oriented at right angles to the inlet 22 or, to be more exact, to a refrigerant duct 38 of the compressor housing 18 opening therein. The receptacle 36 opens into the inlet 22 or, to be more exact, into the refrigerant duct 38.

The refrigerant sensor 6 exhibits on the front side an external thread 40 which has been screwed into the thread of the receptacle 36 in form-closed and/or force-closed manner for the purpose of installation. For the purpose of sealing, a protruding edge has been molded onto the compressor housing 18 as a sealing face 42 which surrounds an external aperture of the receptacle 36. The refrigerant sensor 6 exhibits a sealing element 44 in the form of an O-ring which is brought into sealing abutment with the sealing face 42 when the external thread 40 is screwed into the receptacle 36.

The disclosure is not restricted to the embodiment examples described above.

Rather, other variants of the invention can also be derived therefrom within the scope of the disclosed claims by a person skilled in the art without departing from the subject-matter of the disclosure. In particular, all the individual features described in connection with the various embodiment examples are, furthermore, capable of being combined in other ways within the scope of the disclosed claims without departing from the subject-matter of the disclosure.

For instance, in an embodiment which is not shown in any detail, a joining pin has been inserted into the compressor housing 18 or into the aluminum block 12, a corresponding (receiving) bore having been provided in the respective other component 12, 18.

### LIST OF REFERENCE SYMBOLS

2 refrigerant assembly
4 refrigerant drive/compressor, scroll compressor
6 component, refrigerant sensor
8 component, heat-exchanger assembly
10 base plate
12 aluminum block
14 nozzle
16 heat-exchanger
18 drive housing, compressor housing
20 electronics region
22 refrigerant aperture, inlet
24 refrigerant aperture, outlet
26 refrigerant duct
28 receptacle
30 through-bore
32 threaded bore
34 screw element
36 receptacle, threaded bore
38 refrigerant duct
40 external thread
42 sealing face
44 sealing element

1. A refrigerant assembly (2) for a motor vehicle, exhibiting an electric refrigerant drive (4) and at least one further component (6, 8), wherein the refrigerant drive (4) exhibits a drive housing (18) with at least one refrigerant aperture (22, 24), and wherein the component (6, 8) has been joined, or is capable of being joined, directly to the refrigerant aperture (22, 24).

2. The refrigerant assembly (2) as claimed in claim 1, wherein the component (6) is a refrigerant sensor,
wherein
an interface for accommodating the refrigerant sensor (6) has been inserted into the drive housing (18) at right angles to the refrigerant aperture (22).

3. The refrigerant assembly (2) as claimed in claim 2,
wherein
the interface exhibits a threaded bore (36) into which an external thread (40) of the refrigerant sensor (6) has been screwed.

4. The refrigerant assembly (2) as claimed in claim 2,
wherein
the interface exhibits a sealing face (42) molded onto the drive housing (18), against which a sealing element of the refrigerant sensor (6) bears in sealing manner.

5. The refrigerant assembly (2) as claimed in claim 4,
wherein
the sealing element (44) is an O-ring.

6. The refrigerant assembly (2) as claimed in claim 1, wherein the component (8) is a heat-exchanger assembly, and wherein the heat-exchanger assembly (8) is provided and configured for the purpose of conducting refrigerant,
wherein
a fluidic connection has been realized between the refrigerant aperture (22) and the heat-exchanger assembly (8).

7. The refrigerant assembly (2) as claimed in claim 6,
wherein
the heat-exchanger assembly (8) exhibits an aluminum block (12) by way of interface to the refrigerant aperture (22).

8. The refrigerant assembly (2) as claimed in claim 6,
wherein
the heat-exchanger assembly (8) exhibits a protruding nozzle (14) which has been inserted in sealing manner into a receptacle (28) of the refrigerant aperture (22).

9. The refrigerant assembly (2) as claimed in claim 6,
wherein
a through-bore (30), adjacent to the refrigerant aperture (22), has been introduced into the drive housing (18), a screw element (34), which has been screwed into a threaded bore (32) for the purpose of force-closed fixing of the heat-exchanger assembly (8), being seated in the through-bore (30).

10. The refrigerant assembly (2) as claimed in claim 6,
wherein
the drive housing (18) exhibits a protruding joining pin which engages in a receiving bore of the heat-exchanger assembly (8).
